(19) United States
(12) Patent Application Publication
(10) Pub. No.: US 2007/0111688 A1
(43) Pub. Date: May 17, 2007

(54) RADIO RECEIVER

(75) Inventors: Takeshi Ueno, Minato-ku, Tokyo (JP); Tetsuro Itakura, Minato-ku, Tokyo (JP); Rui Ito, Minato-ku, Tokyo (JP); Hiroshi Yoshida, Minato-ku, Tokyo (JP); Hidenori Okuni, Minato-ku, Tokyo (JP)

Correspondence Address: AMIN, TUROCY & CALVIN, LLP, 1900 EAST 9TH STREET, NATIONAL CITY CENTER, 24TH FLOOR,, CLEVELAND, OH, 44114, US

(73) Assignee: KABUSHIKI KAISHA TOSHIBA, Tokyo (JP)

(21) Appl. No.: 11/558,785

(22) Filed: Nov. 10, 2006

(30) Foreign Application Priority Data
Nov. 11, 2005 (JP) 2005-327806

(51) Int. Cl. G06F 3/033

(52) U.S. Cl. 455/130

(57) ABSTRACT

A radio receiver, including: a receiver configured to receive a radio signal; a frequency converter configured to generate a baseband signal by converting frequency the radio signal; a subtractor configured to generate a differential signal by subtracting an analog signal from the baseband signal; an amplifier configured to generate an amplified differential signal by amplifying the difference signal by a first amplification factor or a second amplification factor; an analog-digital converter configured to convert the amplified difference signal to a digital signal; an integrator configured to generate an integration signal by integrating a value indicated by the digital signal; a memory configured to store the integration signal into a first address when the amplifier amplifies the difference signal by the first amplification factor, and configured to store the integration signal into a second address when the amplifier amplifies the difference signal by the second amplification factor; and a digital-analog converter configured to generate the analog signal by converting the integration signal stored in the first address of the memory when the amplifier amplifies the difference signal by the first amplification factor, and configured to generate the analog signal by converting the integration signal stored in the second address of the memory when the amplifier amplifies the difference signal by the second amplification factor.

### CROSS REFERENCE TO RELATED APPLICATIONS

This application is based upon and claims a benefit of priority under 35 U.S.C. § 119 from prior Japanese Patent Application P2005-327806 filed on Nov. 11, 2005, the entire contents of which are incorporated by reference herein.

### BACKGROUND

1. Technical Field

Exemplary embodiments of the invention relate to a radio receiver that has an offset cancellation function of a variable gain amplifier.

2. Discussion of the Background

JP-B-3486058 discloses a method for canceling a DC offset of a variable gain amplifier in a radio receiver. A Variable Gain Amplifier (VGA) amplifies analog signal from an input section. A converted analog signal is further converted to digital signal by an analog-digital converter (ADC) after several processing acts, such as frequency converting, filtering, etc. An offset detector detects a DC offset component of output signal from the VGA by observing output of the ADC in idle state of the radio receiver. The offset detector generates DC offset cancel signal to input to the VGA by converting the DC offset component. The output of the offset detector is stored in a memory. In a reception state of the radio receiver, the DC offset cancel signal stored in the memory is subtracted from the analog signal from the input section. The VGA amplifies a difference between the DC offset cancel signal stored in the memory and the analog signal from the input section.

On one hand, such method works well in a system in which the VGA's gain is static during receiving one flame, such a TDD (Time Division Duplex) system. On the other hand, systems such as a CDMA (Code Division Multiple Access) system require gain tuning without breaking the reception process.

As described above, a plurality of input-referred DC offset values, which correspond to each of gain values of a VGA respectively, are stored in a memory. Those values are respectively read out when correspond gain value is set to the VGA, during a stage of receiving transmission signal.

Detecting a DC offset requires a long time constant filter. To obtain stable output of the filter, which is the DC offset value, requires long transient duration.

### SUMMARY

The following presents a simplified summary in order to provide a basic understanding of one or more aspects of the invention. This summary is not an extensive overview of the invention. It is not intended to identify key or critical elements, nor to delineate the scope of the claimed subject matter. Rather, the sole purpose of this summary is to present some concepts of the invention in a simplified form as a prelude to the more detailed description that is presented hereinafter.

According to an exemplary embodiment, one aspect of the invention is a radio receiver, including: a receiver configured to receive a radio signal; a frequency converter configured to generate a baseband signal by converting frequency of the radio signal; a subtractor configured to generate a differential signal by subtracting an analog signal from the baseband signal; an amplifier configured to generate an amplified differential signal by amplifying the differential signal by a first amplification factor or a second amplification factor; an analog-digital converter configured to convert the amplified differential signal to a digital signal; an integrator configured to generate an integration signal by integrating a value indicated by the digital signal; a memory configured to store the integration signal into a first address when the amplifier amplifies the differential signal by the first amplification factor, and configured to store the integration signal into a second address when the amplifier amplifies the differential signal by the second amplification factor; and a digital-analog converter configured to generate the analog signal by converting the integration signal stored in the first address of the memory when the amplifier amplifies the differential signal by the first amplification factor, and configured to generate the analog signal by converting the integration signal stored in the second address of the memory when the amplifier amplifies the differential signal by the second amplification factor.

Another aspect of the invention relates to a method of operating a radio receiver involving setting a first gain of a variable gain amplifier to a first value and setting a first address of a memory for writing and reading; storing a first integrated digital value into the first address of the memory; setting a second gain of the variable gain amplifier to a second value and setting a second address of the memory for writing and reading; storing a second integrated digital value into the second address of the memory; inhibiting writing into the memory; and setting a third gain of the variable gain amplifier to a third value and setting a third address of the memory for reading.

Yet another aspect of the invention relates to a method of operating a radio receiver involving generating a radio signal from a reception signal; generating a baseband signal by converting frequency of the radio signal; generating a differential signal by subtracting an analog signal from the baseband signal; generating an amplified difference signal by amplifying the difference signal by a first amplification factor or a second amplification factor; converting the amplified difference signal to a digital signal; generating an integration signal by integrating a value indicated by the digital signal; storing the integration signal into a first address when the amplifier amplifies the difference signal by the first amplification factor, and storing the integration signal into a second address when the amplifier amplifies the difference signal by the second amplification factor; and generating the analog signal by converting the integration signal stored in the first address when the amplifier amplifies the difference signal by the first amplification factor, and generating the analog signal by converting the integration signal stored in the second address when the amplifier amplifies the difference signal by the second amplification factor.

To the accomplishment of the foregoing and related ends, the invention, then, comprises the features hereinafter fully described. The following description and the annexed drawings set forth in detail certain illustrative aspects of the invention. However, these aspects are indicative of but a few of the various ways in which the principles of the invention may be employed. Other aspects, advantages and novel features of the invention will become apparent from the following description when considered in conjunction with the drawings.

### BRIEF DESCRIPTION OF THE SEVERAL VIEWS OF THE DRAWINGS

The invention and attendant advantages therefore are best understood from the following description of the non-limiting embodiments when read in connection with the accompanying Figures, wherein:

FIG. 1 is a diagram illustrating an example of a radio receiver according to a first exemplary embodiment;

FIG. 2 is a flow chart illustrating an operation of the radio receiver according to a first exemplary embodiment;

FIG. 3 is a flow chart illustrating an operation in a DC offset storing step of the radio receiver according to a first exemplary embodiment;

FIG. 4 is a flow chart illustrating an operation in a reception step of the radio receiver according to a first exemplary embodiment;

FIG. 5 is a block diagram illustrating a transfer function of an integrator according to a first exemplary embodiment;

FIG. 6 is a diagram indicating frequency characteristic of digital signal OUT according to a first exemplary embodiment;

FIG. 7 is a diagram illustrating an example of a radio receiver according to a second exemplary embodiment;

FIG. 8 is a flow chart illustrating an operation in a DC offset storing step of the radio receiver according to a second exemplary embodiment;

FIG. 9 is a flow chart illustrating an operation in a reception step of the radio receiver according to a second exemplary embodiment;

FIG. 10 is a flow chart illustrating an operation in a reception step of the radio receiver according to a third exemplary embodiment;

FIG. 11 is a diagram illustrating an example of a radio receiver according to a fourth exemplary embodiment;

FIG. 12 is a flow chart illustrating an operation in a reception step of the radio receiver according to a fourth exemplary embodiment;

FIG. 13 is a flow chart illustrating an operation in a reception step of the radio receiver according to a fifth exemplary embodiment;

FIG. 14 is a flow chart illustrating an operation in a reception step of the radio receiver according to a modification of a fifth exemplary embodiment;

FIG. 15 is a table indicating correspondence among addresses of a memory, gain of a VGA, gain of a HFA, and frequency of local signal according to a modification of a fifth exemplary embodiment

FIG. 16 is a diagram illustrating an example of a radio receiver according to a sixth exemplary embodiment;

FIG. 17 is a flow chart illustrating an operation of the radio receiver according to a sixth exemplary embodiment;

FIG. 18 is a block diagram illustrating a transfer function of an integrator according to a seventh exemplary embodiment;

FIG. 19 is a flow chart illustrating an operation of the radio receiver according to a seventh exemplary embodiment;

FIG. 20 is a flow chart illustrating an operation of the radio receiver according to a modification of a seventh exemplary embodiment;

FIG. 21 is a flow chart illustrating an operation of the radio receiver according to an eighth exemplary embodiment;

FIG. 22 is a diagram illustrating an example of a VGA/DAC according to an eighth exemplary embodiment;

FIG. 23 is a diagram illustrating an example of a radio receiver according to a ninth exemplary embodiment; and

FIG. 24 is a block diagram illustrating a transfer function of a digital offset detector according to a ninth exemplary embodiment.

### DETAILED DESCRIPTION

Referring now to the Figures in which like reference numerals designate identical or corresponding parts throughout the several views.

### FIRST EXEMPLARY EMBODIMENT

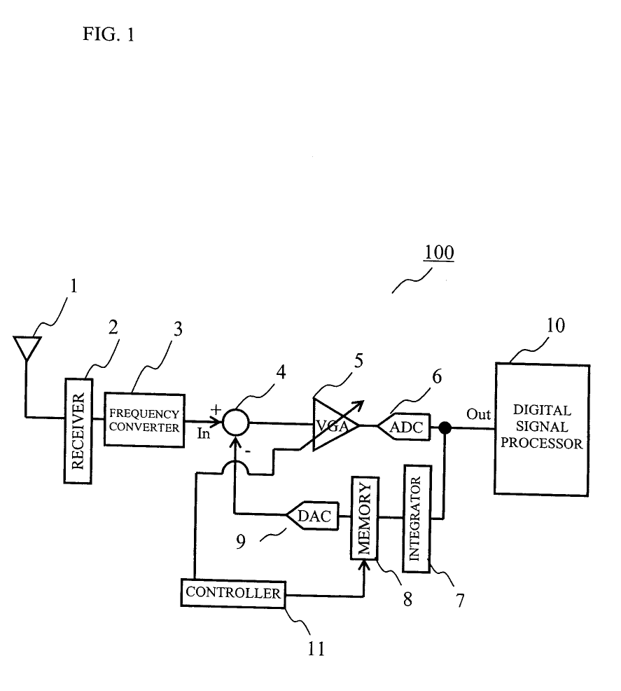

FIG. 1 illustrates a diagram of an example of a first exemplary embodiment of a radio receiver 100.

The radio receiver 100 includes an antenna 1, a receiver 2, a frequency converter 3, a subtractor 4, a VGA (Variable Gain Amplifier) 5, an analog-digital converter (ADC) 6, an integrator 7, a memory 8, a digital-analog converter (DAC) 9, a digital signal processor 10, and a controller 11.

The antenna 1 receives a radio signal, such as a reception signal, that includes transmission information. The receiver 2 performs amplification processing and filtering to the radio signal that is received by the antenna 1. The frequency converter 3 converts the radio signal to a baseband signal by changing the frequency. The subtractor 4 generates a differential signal by subtracting an analog feedback signal, which is an output signal from the DAC 9, from the baseband signal.

The VGA 5 amplifies the output, such as the differential signal, of the subtractor 4. The VGA 5 generates an amplified differential signal by amplifying the differential signal by one or more amplification factors. Gain A of the VGA 5 changes according to a baseband gain control signal generated by the controller 11. The gain of the VGA 5 can be changed to multiple levels. In this embodiment, the gain A of the VGA 5 changes between A1 and A2 selectively.

The ADC 6 converts the output of the VGA 5 to a digital signal OUT. That is, the ADC 6 converts the amplified differential signal to a digital signal. The digital signal processor 10 reproduces the transmission information from the digital signal OUT.

The integrator 7 integrates a digital value indicated by the digital signal OUT, and outputs the integrated digital value. The cut off frequency of the integrator 7 is designed so that it is lower than the frequency of the baseband signal. The integrator 7 generates an integration signal by integrating the digital value indicated by the digital signal.

The memory 8 stores the integrated digital value to an address designated by a write address control signal output from the controller 11. Moreover, the memory 8 outputs the integrated digital value from an address designated by a read address control signal output from the controller 11. In this embodiment, addresses M1 and M2 are defined in the memory 8

The DAC 9 converts the integrated digital value to an analog feedback signal for outputting to the subtractor 4. When the VGA 5 amplifies the differential signal by an amplification factor, the DAC 9 generates the analog signal by converting the integration signal stored in an address of the memory 8.

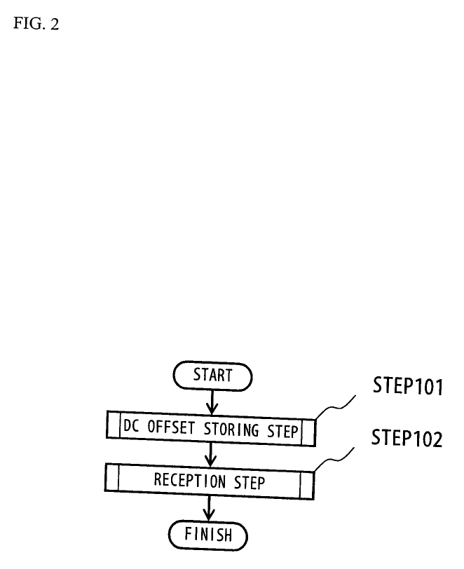

FIG. 2 is a flow chart of an operation of the radio receiver 100. The radio receiver 100 performs a DC offset storing step 101 before a reception step 102.

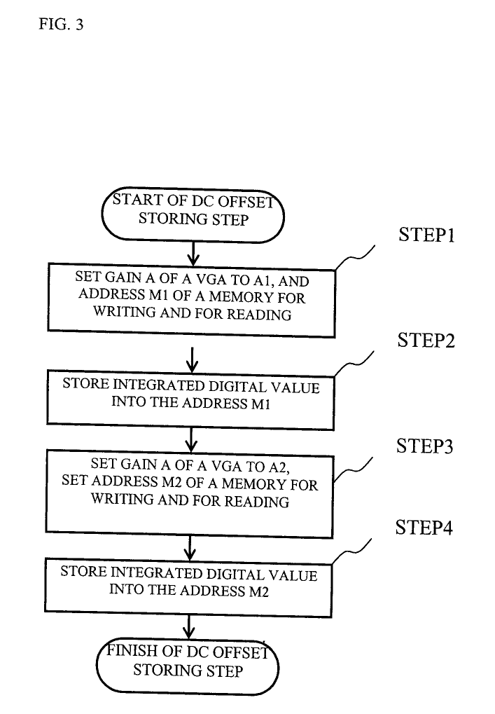

FIG. 3 is a flow chart of the operation in the DC offset storing step 101 of the radio receiver 100 operation. First, for example, the gain A of the VGA 5 is set to A1, and the address M1 of the memory 8 is set for writing the integrated digital value from the integrator 7 into and for reading the integrated digital value out to the DAC 9 (Step 1).

Next, the integrated digital value from the integrator 7 is stored into the address M1 of the memory 8 (Step 2). The VGA 5 outputs the amplified signal including the DC offset component. The integrated digital value from the integrator 7 is not a transient value, but a steady value obtained after a suitable period of time elapses. The DAC 9 converts the integrated digital value stored in the address M1 of the memory 8 to an analog feedback signal. The analog feedback signal is subtracted from the baseband signal at the subtractor 4. The integrator 7, the memory 8, and the DAC 9 make up a negative feedback loop path about the frequency band passing through the integrator 7. The DC offset component of the output signal from the VGA 5 is canceled by the effect of the negative feedback loop path. It can be considered that the integrated digital value in the state where the DC offset component was canceled is input-referred DC offset. Then, an input-referred DC offset at the gain A1 is stored in the address M1.

Next, the gain A of the VGA 5 is set to A2, and the address M2 of the memory 8 is set for writing the integrated digital value from the integrator 7 into and for reading the integrated digital value out to the DAC 9 (Step 3). The integrated digital value from the integrator 7 is not a transient value, but a steady value obtained after a suitable period of time elapses.

Next, the integrated digital value from the integrator 7 is stored into the address M2 of the memory 8 (Step 4). The integrated digital value from the integrator 7 is not a transient value, but a steady value obtained after a suitable period of time elapses. Then, an input-referred DC offset at the gain A2 is stored in the address M2.

Input-referred DC offsets are stored into addresses of the memory 8 for each gain value as described above.

The DC offset storing step 101 may be executed at a time in a break of a transmission information reproduction from the digital signal OUT in the digital signal processor 10, at a time when the radio receiver 100 is powered on, and/or at a time when the radio receiver 100 is in an idle state.

The reception step 102 may be executed during a transmission information reproduction from the digital signal OUT in the digital signal processor 10.

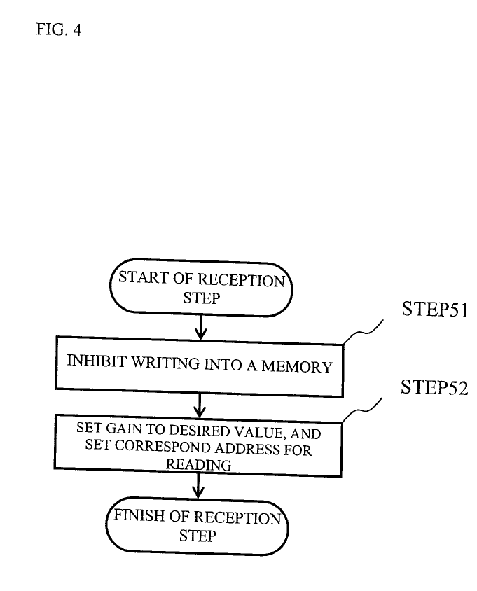

FIG. 4 is a flow chart of the operation in the reception step 102 of the radio receiver 100 operation. First, writing into the memory 8 is inhibited (Step 51). That is, no address in the memory 8 is set for writing. Next, the gain of the VGA 5 is set to a desired value, and an address of the memory 8, where the input-referred DC offset corresponding to the selected gain is stored, is set for reading. That is, the address M1 is set for reading when the gain of the VGA 5 is set to the A1, and the address M2 is set for reading when the gain of the VGA 5 is set to the A2 (Step 52). When changing the gain of the VGA 5 to a different value, the address for reading is also changed to the address corresponding to the different value of the gain.

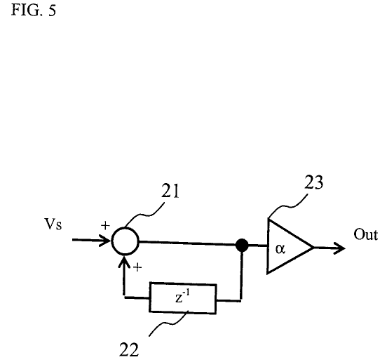

FIG. 5 is a block diagram of a transfer function of the integrator 7. The integrator 7 is expressed with a combination of an addition element 21, a delay element 22, and a multiplication element 23. A transfer function of the delay element 22 is z-1. A transfer function of the multiplication element 23 is α.

An input signal of the integrator 7, which is the digital signal OUT, is provided to the addition element 21 as two signals, one of them is directly, and the other is through the delay element 22. The addition element 21 provides an addition of the two signals to the multiplication element 21. The multiplication element 22 generates a signal, which is obtained by multiplying the coefficient a to the signal provided by the addition element 21, as the integrated digital value.

Then, the transfer function of the integrator 7 can be expressed with equation (1).
α/(1−z⁻¹) (1)

Furthermore,

$$OUT ( z ) = \frac{A}{1 + A \frac{α}{1 - {z}^{- 1}}} Vs ( z ) \qquad ( 2 )$$

Here, the Vs represents the input-referred DC offset in FIG. 1, and the A represents the gain of the VGA5.

The frequency characteristic of the digital signal OUT can be expressed as equation (3).

$$OUT ( jω ) = \frac{A}{1 + A \frac{α}{1 - exp ( - jω T )}} Vs ( jω ) \qquad ( 3 )$$

Here, The T represents a sampling period.

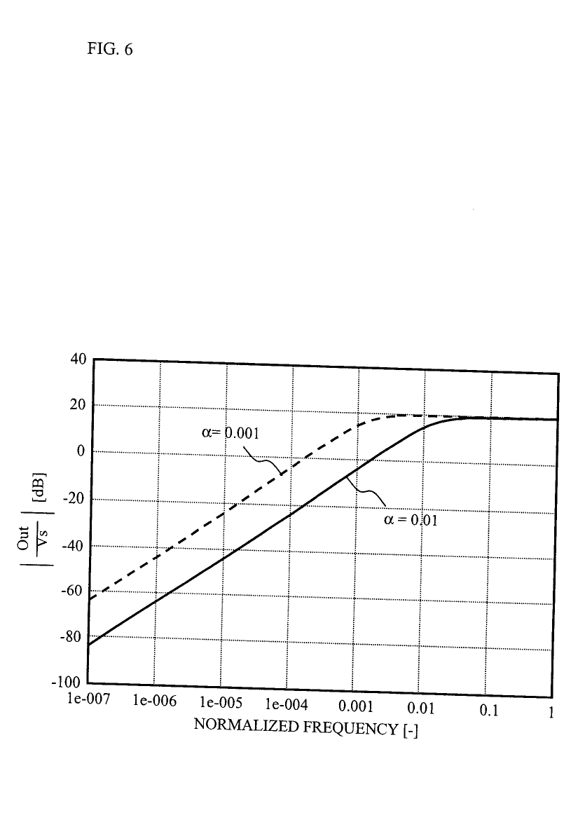

FIG. 6 shows a diagram indicating the frequency characteristic of the digital signal OUT. In this figure, a horizontal axis indicates frequency normalized by the sampling period T, and a vertical axis indicates an absolute value of OUT(jω)/Vs(jω). A solid line indicates the amplitude characteristic when the A=10 and the α=0.001, and a broken line indicates the amplitude characteristic when the A=10 and the α=0.01. It is understood that the frequency characteristic of the integrator is “high-path”. Therefore, the DC offset component is reduced.

As described above, a plurality of input-referred DC offset values, which correspond to each of the gain values of a VGA respectively, are stored in a memory. Those values are respectively read out when a corresponding gain value is set to the VGA, during the stage of receiving a transmission signal.

It makes not performing offset detection for every gain change during a stage of receiving transmission signal without breaking the reception process, and completing DC offset cancellation immediately from the gain change, possible.

In addition, when the gain of the VGA is relatively small, there is a danger of the detection error of the input-referred DC offset for storing in the memory at the DC offset storing step since a loop gain of the negative feedback is relatively low.

Therefore, it is permissible to cancel input-referred DC offsets corresponding to relatively low gains of the VGA. That is, it is permissible not to store the input-referred DC offsets, and is permissible not to prepare memory space for them.

### SECOND EXEMPLARY EMBODIMENT

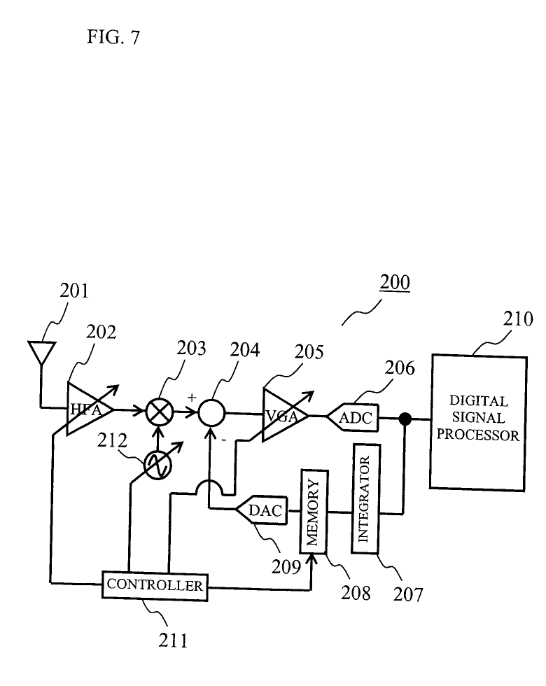

FIG. 7 illustrates a diagram of an example of a second exemplary embodiment of a radio receiver 200. In the radio receiver 200, DC offset risen in upstream than the VGA 5 also be cancelled.

In addition to the components of the radio receiver 100 in the first exemplary embodiment, the radio receiver 200 further includes an HFA (High Frequency Amplifier) 202, a mixer 203, and a local oscillator 212.

A signal input interface 201 receives a radio signal, such as a reception signal, that includes transmission information. The signal input interface 201 may be an antenna presented in the figure, or, an interface device for receiving wired signaling.

The HFA 202 amplifies the output of the signal input interface 201. The HFA 202 generates an amplified signal by amplifying the output of the signal input interface 201 by one or more amplification factors. The gain of the HFA 202 can be changed to multiple levels. Gain B of the HFA 202 changes according to an HFA gain control signal generated by the controller 211. In this embodiment, the gain B of the HFA 202 changes between B1 and B2 selectively.

The mixer 203 generates baseband signal IN by down-converting the output of the HFA 202 using a local signal LO. The subtractor 204 generates a differential signal by subtracting an analog feedback signal, which is an output signal from the DAC 209, from the baseband signal.

The VGA 205 amplifies the output, such as the differential signal, of the subtractor 204. The VGA 205 generates an amplified differential signal by amplifying the differential signal by one or more amplification factors. Gain A of the VGA 205 changes according to a baseband gain control signal generated by the controller 211. The gain of the VGA 205 can be changed to multiple levels. In this embodiment, the gain A of the VGA 205 selectively changes between A1 and A2.

The ADC 206 converts the output of the VGA 205 to a digital signal OUT. In other words, the ADC 206 converts the amplified analog signal to a digital signal. The digital signal processor 210 reproduces the transmission information from the digital signal OUT.

The integrator 207 integrates a digital value indicated by the digital signal OUT, and outputs the integrated digital value. The cut off frequency of the integrator 207 is designed so that it is lower than the frequency of the baseband signal.

The memory 208 stores the integrated digital value to an address designated by write address control signal output from the controller 211. Moreover, the memory 208 outputs the integrated digital value from an address designated by a read address control signal output from the controller 211. In this embodiment, addresses M1, M2, M3, and M4 are defined in the memory 208.

The DAC 209 converts the integrated digital value to analog feedback signal for outputting to the subtractor 204. When the VGA 5 amplifies the differential signal by an amplification factor, the DAC 209 generates the analog signal by converting the integration signal stored in an address of the memory 208.

The local oscillator 212 generates the local signal LO for down-converting the output of the HFA 202. Frequency of the local signal LO changes according to a local frequency control signal generated by the controller 211. In this embodiment, the frequency of the local signal LO changes between LO1 and LO2 selectively.

The radio receiver 200 performs a DC offset storing step before a reception step just as the radio receiver 100 in the first exemplary embodiment.

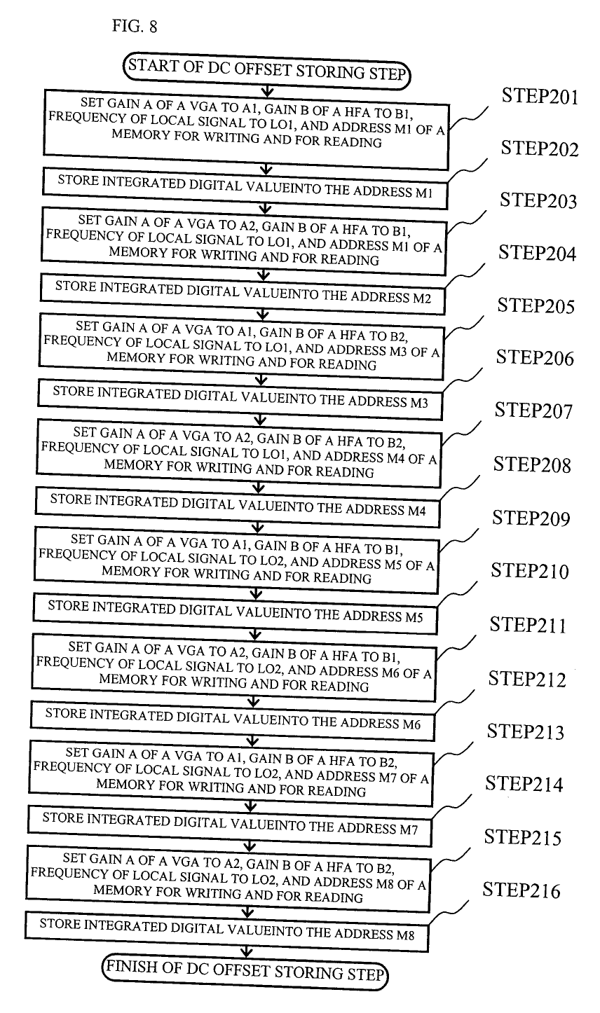

FIG. 8 is a flow chart of the operation in the DC offset storing step of the radio receiver 200. First, for example, the gain A of the VGA 205 is set to A1, the gain B of the HFA 202 is set to B1, the frequency of the local signal LO is set to the LO1, and the address M1 of the memory 208 is set for writing the integrated digital value from the integrator 207 into and for reading the integrated digital value out to the DAC 209 (Step 201).

Next, the integrated digital value from the integrator 207 is stored into the address M1 of the memory 208 (Step 202). The VGA 205 outputs the amplified signal including the DC offset component. The integrated digital value from the integrator 207 is not a transient value, but a steady value obtained after a suitable period of time elapses. The DAC 209 converts the integrated digital value stored in the address M1 of the memory 208 to an analog feedback signal. The analog feedback signal is subtracted from the baseband signal at the subtractor 204. The integrator 207, the memory 208, and the DAC 209 make up a negative feedback loop path about the frequency band passing through the integrator 207. The DC offset component of the output signal from the VGA 205 is canceled by the effect of the negative feedback loop path. It can be considered that the integrated digital value in the state where the DC offset component was canceled is input-referred DC offset.

Next, the gain A of the VGA 205 is set to A2, and the address M2 of the memory 208 is set for writing the integrated digital value from the integrator 207 into and for reading the integrated digital value out to the DAC 209 (Step 203). The gain of the HFA 202 is kept as B1, and the frequency of the local signal LO is kept as the LO1 (Step 203).

Next, the integrated digital value from the integrator 207 is stored into the address M2 of the memory 208 (Step 204). The integrated digital value from the integrator 207 is not a transient value, but a steady value obtained after a suitable period of time elapses.

Next, the gain A of the VGA 205 is set to A1, and the gain of the HFA 202 is set to B2. The address M3 of the memory 208 is set for writing the integrated digital value from the integrator 207 into and for reading the integrated digital value out to the DAC 209. The frequency of the local signal LO is kept as the LO1 (Step 205).

Next, the integrated digital value from the integrator 207 is stored into the address M3 of the memory 208 (Step 206). The integrated digital value from the integrator 207 is not a transient value, but a steady value obtained after a suitable period of time elapses.

Next, the gain A of the VGA 205 is set to A2. The gain of the HFA 202 is kept as B2. The frequency of the local signal LO is kept as the LO1. The address M4 of the memory 208 is set for writing the integrated digital value from the integrator 207 into and for reading the integrated digital value out to the DAC 209 (Step 207).

Next, the integrated digital value from the integrator 207 is stored into the address M4 of the memory 208 (Step 208). The integrated digital value from the integrator 207 is not a transient value, but a steady value obtained after a suitable period of time elapses.

Next, the gain A of the VGA 205 is set to A1, the gain of the HFA 202 is set to B1, and the frequency of the local signal LO is kept as the LO2. The address M5 of the memory 208 is set for writing the integrated digital value from the integrator 207 into and for reading the integrated digital value out to the DAC 209 (Step 209).

Next, the integrated digital value from the integrator 207 is stored into the address M5 of the memory 208 (Step 210). The integrated digital value from the integrator 207 is not a transient value, but a steady value obtained after a suitable period of time elapses.

Next, the gain A of the VGA 205 is set to A2. The gain of the HFA 202 is kept as B1, and the frequency of the local signal LO is kept as the LO2. The address M6 of the memory 208 is set for writing the integrated digital value from the integrator 207 into and for reading the integrated digital value out to the DAC 209 (Step 211).

Next, the integrated digital value from the integrator 207 is stored into the address M6 of the memory 208 (Step 212). The integrated digital value from the integrator 207 is not a transient value, but a steady value obtained after a suitable period of time elapses.

Next, the gain A of the VGA 205 is set to A1, and the gain of the HFA 202 is set to B2. The frequency of the local signal LO is kept as the LO2. The address M7 of the memory 208 is set for writing the integrated digital value from the integrator 207 into and for reading the integrated digital value out to the DAC 209 (Step 213).

Next, the integrated digital value from the integrator 207 is stored into the address M7 of the memory 208 (Step 214). The integrated digital value from the integrator 207 is not a transient value, but a steady value obtained after a suitable period of time elapses.

Next, the gain A of the VGA 205 is set to A2. The gain of the HFA 202 is kept as B2, and the frequency of the local signal LO is kept as the LO2. The address M8 of the memory 208 is set for writing the integrated digital value from the integrator 207 into and for reading the integrated digital value out to the DAC 209 (Step 215).

Next, the integrated digital value from the integrator 207 is stored into the address M8 of the memory 208 (Step 216). The integrated digital value from the integrator 207 is not a transient value, but a steady value obtained after a suitable period of time elapses.

Input-referred DC offsets are stored into addresses of the memory 8 for each gain of the VGA 205, for each gain of the HFA 202, and for each frequency of the local signal LO, as described above. The DC offset storing step may be executed at a time during a break of a transmission information reproduction from the digital signal OUT in the digital signal processor 210, at a time when the radio receiver 200 is powered on, and/or at a time when the radio receiver 200 is in an idle state.

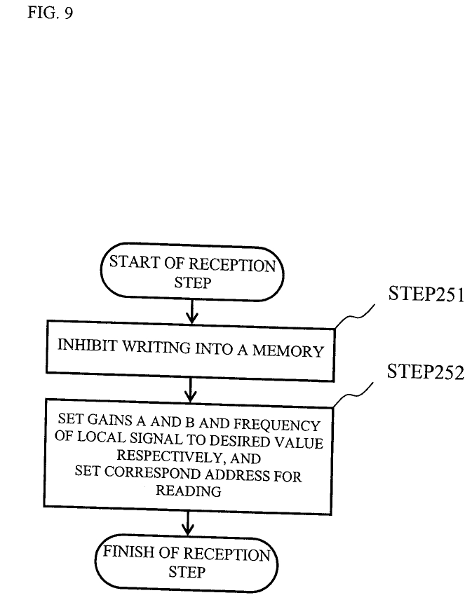

FIG. 9 is a flow chart of the operation in the reception step of the radio receiver 200 operation. First, for example, writing into the memory 208 is inhibited (Step 251). That is, no address in the memory 208 is set for writing. Next, parameters such as the gain of the VGA 205, the gain of the HFA 202, and the frequency of the local signal LO are set to desired values, respectively. An address of the memory 208, where the input-referred DC offset corresponding to the selected parameters is stored, is set for reading. For example, the address M1 is set for reading when the gain of the VGA 205 is set to the A1, the gain of the HFA 202 is set to the B1, and the frequency of the LO is set to LO1 (Step 252).

When changing parameters to a different value, the address for reading is also changed to the address corresponding to the different value of parameters.

The frequency characteristic between the baseband signal IN and the digital signal OUT can be expressed with equation (4).

$$OUT ( jω ) = \frac{A}{1 + A \frac{α}{1 - exp ( - jω T )}} IN ( jω ) \qquad ( 4 )$$

This is similar to equation (3), which indicates the frequency characteristic between the baseband signal IN and the digital signal OUT in the first exemplary embodiment.

Therefore, DC offset component risen in upstream of a VGA (for example, a HFA, a mixer, etc.) can be cancelled.

In addition, there is no need to store all input-referred DC offsets. If there is an unnecessary input-referred DC offset for certain combination of gain of the VGA, gain of the HFA, and a frequency of the local signal LO (for low gain of amplifiers, for example).

### THIRD EXEMPLARY EMBODIMENT

Third exemplary embodiment of a radio receiver is described below, using the diagram of the radio receiver 100 (FIG. 1). The radio receiver in this embodiment can perform cancellation of DC offset keeping on changing during a reception step because of temperature drift.

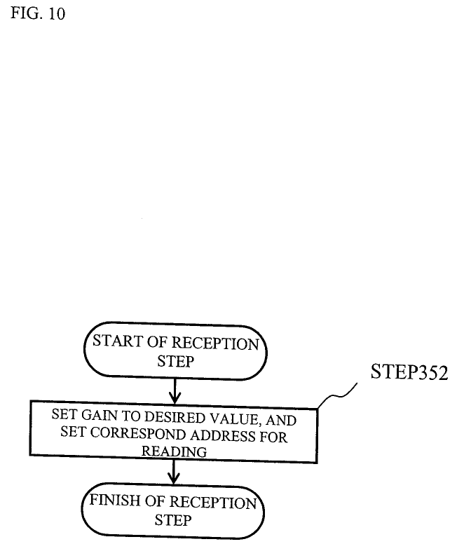

FIG. 10 is a flow chart of another exemplary operation in the reception step of the radio receiver 100. The radio receiver 100 performs the DC offset storing step 101 before the reception step 102 just as the first exemplary embodiment.

First, the gain of the VGA 5 is set to a desired value, and an address of the memory 8, where the input-referred DC offset corresponding to the selected gain is stored, is set for reading, and also for writing. That is, the address M1 is set for both reading and writing when the gain of the VGA 5 is set to the A1, and the address M2 is set for both reading and writing when the gain of the VGA 5 is set to the A2. Note that, a difference between this embodiment and the first exemplary embodiment is that the address for reading is set further for writing (Step 352).

As shown in FIG. 6 with the solid line, a time constant may be about 0.03 Hz if the A=10 and the α=0.001.

Generally, a low frequency component near DC frequency does not have effective information such as a signal component. Therefore, it is made possible to cancel the DC offset without affecting the effective information by setting the cut off frequency of the integrator 7 relatively low.

The change of the DC offset is much slower than the sampling period. Therefore, there is no problem associated with setting the cut off frequency of the integrator 7 relatively low.

As described above, it is possible to perform cancellation of DC offset keeping on changing during a reception step by keeping on updating the input-referred DC offset stored in the memory also during the reception step.

### FOURTH EXEMPLARY EMBODIMENT

Fourth exemplary embodiment of a radio receiver is described below. The radio receiver in this embodiment can perform stabilizing an output of a VGA after changing gain of the VGA in a relatively short time.

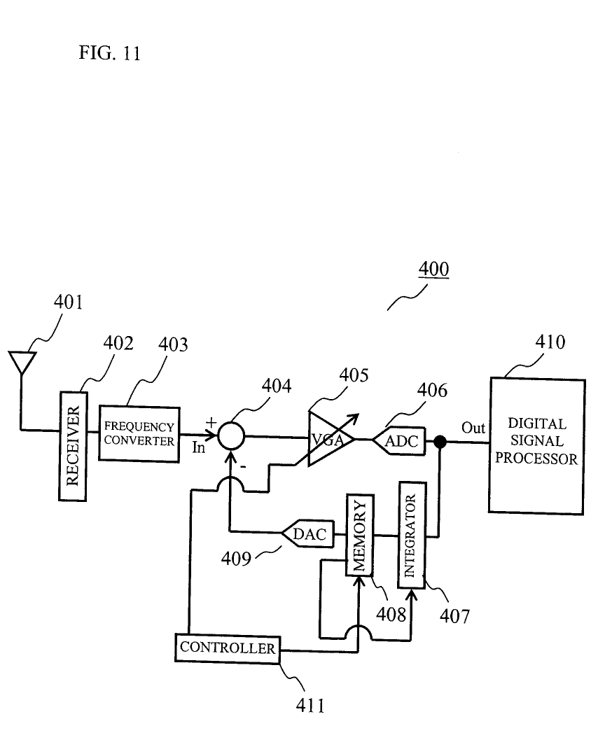

FIG. 11 illustrates a diagram of an example of fourth exemplary embodiment of a radio receiver 400. In this embodiment, an input-referred DC offset stored at an address in a memory 408 is set to an integrator 407 as an initial value when the address is set for reading.

The integrator 407 has a register that stores an integrated digital value generated in a previous 1 clock. The input-referred DC offset stored at the address in the memory 408 is set to the register of the integrator 407 when the address is set for reading. The radio receiver 400 performs a DC offset storing step before a reception step just as the radio receiver 400 in the first exemplary embodiment.

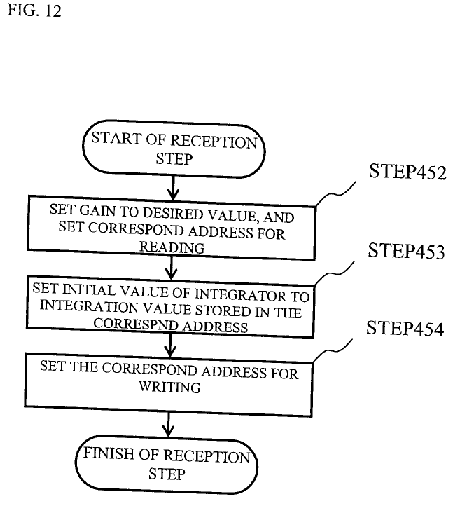

FIG. 12 is a flow chart of the operation in the reception step of the radio receiver 400 operation. First, for example, the gain of the VGA 405 is set to a desired value, and an address of the memory 408, where the input-referred DC offset corresponding to the selected gain is stored, is set for reading (Step 452).

Next, the input-referred DC offset corresponding to the selected gain is set to the register of the integrator 407. That is, the input-referred DC offset corresponding to the selected gain is set as an initial value of the integration of the integrator 408 (Step 453). Next, the address selected in the step 452 is set also for writing (Step 454).

That is, when the gain of the VGA 405 is set to the A1, the address M1 is set for reading, the value stored in the address M1 is set to the register of the integrator 408 as the initial value of integration, and the address M1 is set also for writing. When the gain of the VGA 405 is set to the A2, the address M2 is set for reading, the value stored in the address M2 is set to the register of the integrator 408 as the initial value of integration, and the address M2 is set also for writing.

When changing the gain of the VGA 405 to a different value, the address for reading is also changed to the address corresponding to the different value of the gain, the value stored in the address corresponding to the different value of the gain is set to the register of the integrator 408 as the initial value of integration, and the address for writing is also changed to the address corresponding to the different value of the gain.

As described above, it is maid possible to perform stabilizing an output of a VGA after changing gain of the VGA in a relatively short time, by setting the value stored in the address corresponding to the different value of the gain being set to a register of a integrator as initial value of integration when changing the gain of the VGA to a different value.

If input-referred DC offsets are stored into addresses of the memory 8 for each gain of the VGA 205, for each gain of the HFA 202, and for each frequency of the local signal LO just as the second exemplary embodiment where the radio receiver has a HFA and a local oscillator in upstream of the VGA, it is possible to configure to set the value stored in the address corresponding to the different value of those parameters being set to a register of a integrator as initial value of integration when changing at least one of those parameters.

### FIFTH EXEMPLARY EMBODIMENT

Fifth exemplary embodiment of a radio receiver is described below, using the diagram of the radio receiver 100 (FIG. 1). The radio receiver in this embodiment can perform cancellation of DC offset keeping on changing during a reception step because of temperature drift. The radio receiver 100 performs a DC offset storing step before a reception step just as the radio receiver 100 in the first exemplary embodiment.

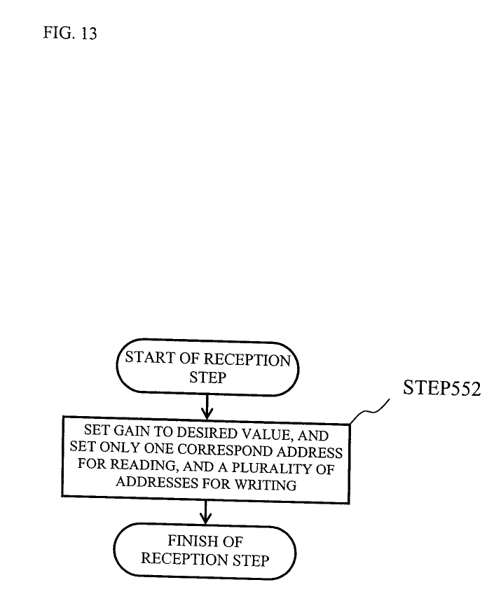

FIG. 13 is a flow chart of the other exemplary operation in the reception step of the radio receiver 100 operation. First, for example, the gain of the VGA 5 is set to a desired value, and an address of the memory 8, where the input-referred DC offset corresponding to the selected gain is stored, is set for reading, and also for writing. Additionally, other addresses of the memory 8 are set for writing (Step 352). That is, when the gain of the VGA 5 is set to the A1, the address M1 is set for both reading and writing, and the address M2 is set for writing. When the gain of the VGA 5 is set to the A2, the address M2 is set for both reading and writing, and the address M1 is set for writing.

When changing the gain of the VGA 5 to a different value, the address for reading is also changed to the address corresponding to a different value of the gain, and the address for writing is also changed to addresses including the address corresponding to a different value of the gain and other address.

As described above, it is possible to perform cancellation of DC offset keeping on changing during a reception step by keeping on updating the input-referred DC offset stored at not only an address corresponding to the selected gain but also another address in the memory also during the reception step.

If input-referred DC offsets are stored into addresses of the memory 8 for each gain of the VGA 205, for each gain of the HFA 202, and for each frequency of the local signal LO just as the second exemplary embodiment where the radio receiver has a HFA and a local oscillator in upstream of the VGA, it is possible to configure to set addresses, which includes not only an address corresponding to the selected parameters but also other address in the memory, for writing.

### MODIFICATION OF FIFTH EXEMPLARY EMBODIMENT

A modification of selection pattern of addresses for writing is described below, using the diagram of the radio receiver 200 (FIG. 7).

In this embodiment, the gain A of the VGA 205 selectively changes between A1, A2, A3, and A4 (here, A1<A2<A3<A4). The gain B of the HFA 202 selectively changes between B1 and B2 (B1>B2). The frequency of the local signal LO changes between LO1 and LO2 (LO1<LO2) selectively. Addresses from M1 to M24 are defined in the memory 208. The radio receiver 200 performs the DC offset storing step before the reception step just as the second exemplary embodiment.

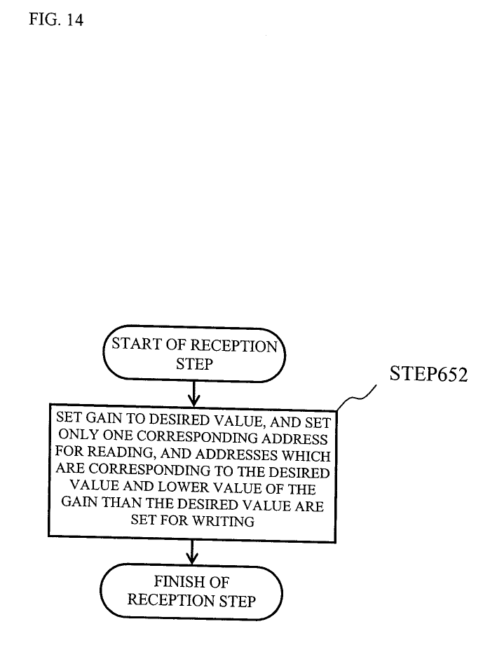

FIG. 14 is a flow chart of the other exemplary operation in the reception step of the radio receiver 200 operation. First, for example, the gain of the VGA 205 is set to a desired value, and an address of the memory 208, where the input-referred DC offset corresponding to the selected gain is stored, is set for reading, and also for writing. Additionally, other addresses, which are corresponding to relatively lower values of the gain of the VGA 205 than the desired value, are set for writing, also (Step 652).

When changing the gain of the VGA 205 to a different value, the address for reading is also changed to the address corresponding to that different value, and the addresses for writing are also changed to addresses corresponding to the different value and relatively lower values than the different value.

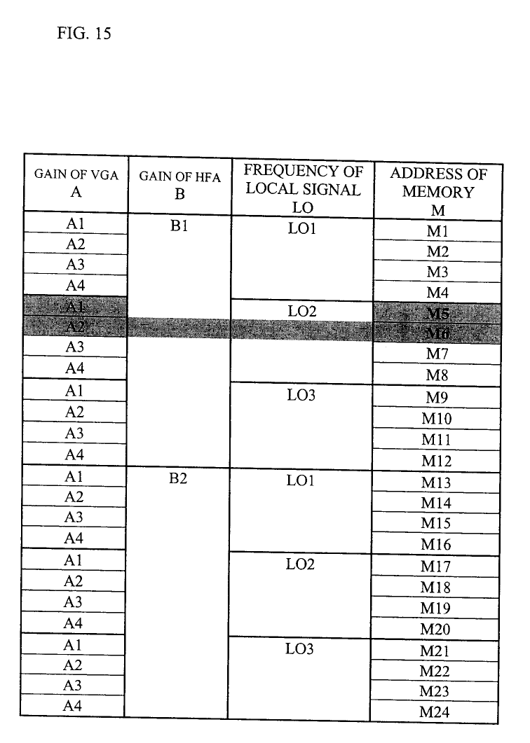

FIG. 15 is a table of addresses of the memory 208 corresponding to the gain A of VGA 205, the gain B of the HFA 202, and the frequency of the local signal LO. For example, the address M1 corresponds to A1, B1, and LO1. The address M5 corresponds to A1, B1, and LO2. The address M6 corresponds to A2, B1, and LO2.

The address M6 is set for reading and also for writing, and the address M5 is set for writing when the gain A of the VGA 205 is set to A2, the gain B of the HFA 202 is set to B1, and the frequency of the local signal LO is set to LO2. The address M5 corresponds to the gain A1 that is lower than the gain A2 corresponding to the address M6.

If fluctuation of the input-referred DC offset does not relate to gain change of the VGA, input-referred DC offsets stored in each of the addresses of the memory 208 corresponding to each gain of the VGA 205 must be same value.

There is a danger of the detection error of the input-referred DC offset for storing in the memory at the DC offset storing step since loop gain of the negative feedback is relatively low when the gain of the VGA is relatively small.

If a large error value is stored in addresses corresponding to a relatively high gain of the VGA 205, the output of the VGA peaks out when the relatively high gain is set to the VGA 205. To avoid it, addresses corresponding to gains higher than the selected gain are not to be set for writing.

As described above, it is possible to perform cancellation of DC offset keeping on changing during a reception step by keeping on updating the input-referred DC offset stored at not only an address corresponding to the selected gain but also other address corresponding to gains lower than the selected gain in the memory also during the reception step.

In addition, it is possible to keep on updating the input-referred DC offset stored at not only an address corresponding to the selected gain of the HFA but also other addresses corresponding to gains of the HFA lower than the selected gain in the memory during the reception step.

### SIXTH EXEMPLARY EMBODIMENT

Sixth exemplary embodiment of a radio receiver is described below. This embodiment is suitable for situations when a baseband signal is not high enough to neglect the DC frequency.

The frequency characteristic of the integrator is “low-pass”. Therefore, DC offset component is reduced enough if the cut off frequency of the integrator is designed so as to be lower than the frequency of the baseband signal. However, if the frequency of the baseband signal is not suitably higher than the DC offset component, the integrator cannot reduce DC component enough. Then, the residual DC component of the baseband signal is fed back to the VGA.

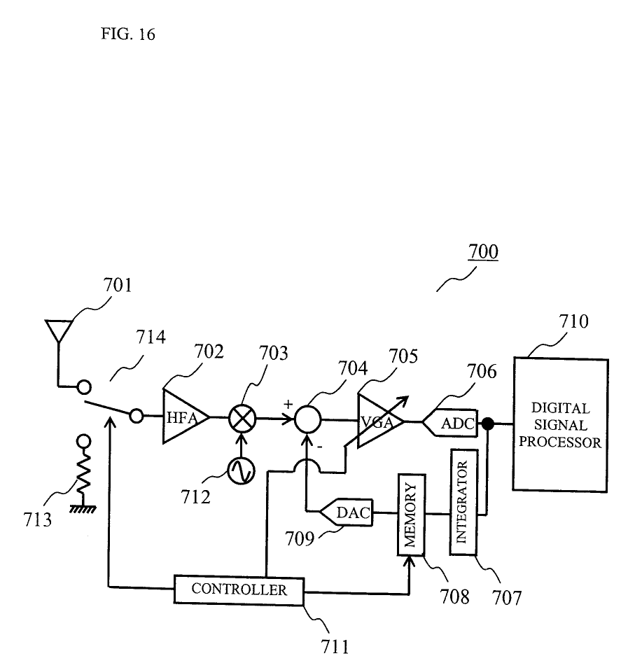

In this embodiment, baseband signal is shut off in DC offset storing step to cutoff the residual DC component of the baseband signal. FIG. 16 illustrates a diagram of an example of this embodiment of a radio receiver 700.

The radio receiver 700 includes a signal receiver 701, a HFA 702, a mixer 703, a subtractor 704, a VGA 705, an ADC 706, an integrator 707, a memory 708, a DAC 709, a digital signal processor 710, a controller 711, a local oscillator 712, a resistor 713, and a switch 714.

The signal receiver 701 receives a radio signal, such as a reception signal, that includes transmission information. Although the signal receiver 701 is drawn as an antenna in FIG. 16, the signal receiver 701 may be a terminal to connect a cable for providing a signal. An end of the resistor 713 is grounded. The resistor 713 is for impedance matching.

The switch 714 connects the signal receiver 701 and the HFA 702, or another end of the resistor 713 and the HFA 702, selectively according to a switching signal from the controller 711. The HFA 702 amplifies the output of the switch 714. The local oscillator 712 generates the local signal LO for down-converting the output of the HFA 702. The mixer 703 generates a baseband signal by down-converting the output of the HFA 202 using local signal LO. The subtractor 704 generates a differential signal by subtracting an analog feedback signal, which is an output signal from the DAC 709, from the baseband signal.

The VGA 705 amplifies the differential signal from the subtractor 704. The VGA 705 generates an amplified differential signal by amplifying the differential signal by one or more amplification factors. Gain A of the VGA 705 changes according to a baseband gain control signal generated by the controller 711. The gain of the VGA 705 can be changed to multiple levels. In this embodiment, the gain A of the VGA 705 selectively changes between A1 and A2.

The ADC 706 converts the output of the VGA 705 to a digital signal OUT. That is, the ADC 706 converts the amplified differential signal to a digital signal. The digital signal processor 710 reproduces the transmission information from the digital signal OUT.

The integrator 707 integrates a digital value indicated by the digital signal OUT, and outputs the integrated digital value. The cut off frequency of the integrator 707 is designed so that it is lower than the frequency of the baseband signal. The integrator generates an integration signal by integrating the digital value indicated by the digital signal.

The memory 708 stores the integrated digital value to an address designated by write address control signal output from the controller 711. Moreover, the memory 708 outputs the integrated digital value from an address designated by a read address control signal output from the controller 711. In this embodiment, addresses M1 and M2 are defined in the memory 708.

The DAC 709 converts the integrated digital value to an analog feedback signal for outputting to the subtractor 704. When the VGA 705 amplifies the differential signal by an amplification factor, the DAC 709 generates the analog signal by converting the integration signal stored in an address of the memory 708.

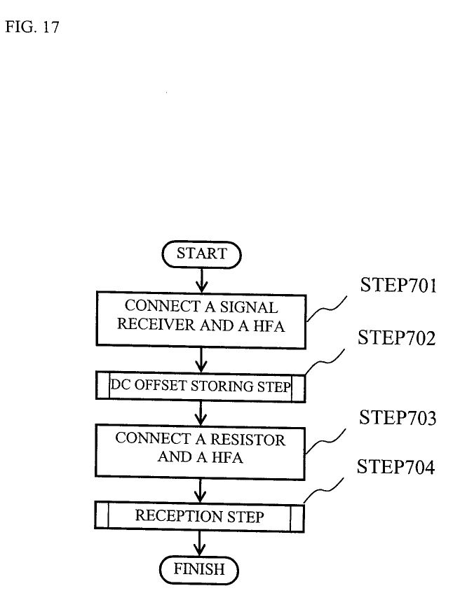

FIG. 17 is a flow chart of an operation of the radio receiver 700. First, for example, the switch 714 connects the resistor 713 and the HFA 702 before a DC offset storing step 702 to cutoff the residual DC component of the baseband signal (Step 701).

Next, the radio receiver 100 performs the DC offset storing step (Step 702). Content of the DC offset storing step is just as the first exemplary embodiment. Next, the switch 714 connects the signal receiver 701 and the HFA 702 (Step 703). Next, a reception step is performed (Step 704). Content of the reception step is just as the first exemplary embodiment. As described above, the residual DC component of the baseband signal can be cut off using a switch.

### SEVENTH EXEMPLARY EMBODIMENT

Seventh exemplary embodiment of a radio receiver is described below, using the diagram of the radio receiver 100 in FIG. 1. This embodiment makes obtaining input-referred DC offset in a relatively short time possible.

As described in the third exemplary embodiment, it is possible to cancel DC offset without affecting the effective information by setting the cut off frequency of the integrator 7 relatively low. But it sometimes causes the problem of slow response time to fluctuation of the DC offset.

To solve this problem, the cutoff frequency of an integrator is set to a relatively high frequency in a DC offset storing step, and the cutoff frequency of an integrator is set to a relatively low frequency in a reception step. In this embodiment, time constant of the integrator 707 can change according to a time constant control signal provided from the controller 711.

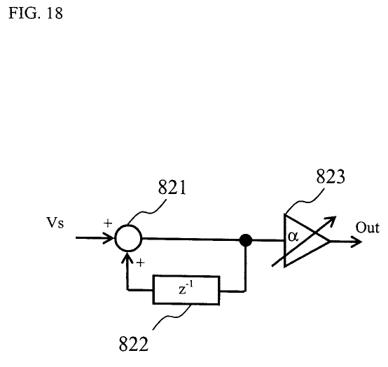

FIG. 18 is a diagram of transfer function of the integrator 707 in this embodiment. The integrator 707 is expressed with combination of an addition element 821, a delay element 822, and a variable multiplication element 823. A transfer function of the delay element 822 is z−1. A transfer function of the variable multiplication element 823 is α.

An input signal of the integrator 707, which is the digital signal OUT, is provided to the addition element 821 as two signals, one of them is directly, and the other is through the delay element 822. The addition element 821 provides an addition of the two signals to the multiplication element 821. The multiplication element 822 generates a signal, which is obtained by multiplying the coefficient α to the signal provided by the addition element 821, as the integrated digital value. The time constant of the integrator 707 can be changed by changing the coefficient α of the variable multiplication element 823.

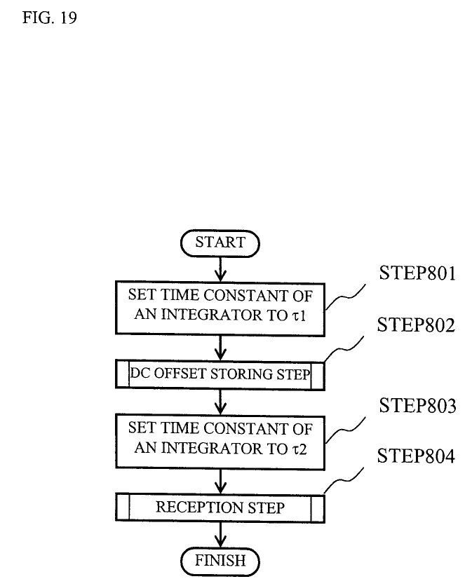

FIG. 19 is a flow chart of an operation of the radio receiver in this embodiment. First, before performing the DC offset storing step 802, the time constant τ of the integrator 707 is set to τ1 (Step 801). The τ1 is smaller than τ2 used in reception step 804. Although it is small, the τ1 is relatively larger than period of baseband signal.

Since the time constant τ of the integrator 707 is relatively small, the output of the integrator 707 is stabilized in a relatively short time. Next, the radio receiver performs the DC offset storing step (Step 802). Content of the DC offset storing step is just as the third exemplary embodiment. Next, before performing the reception step 804, the time constant r of the integrator 707 is set to τ2 (Step 803).

Since the time constant τ of the integrator 707 is relatively large, the baseband signal is well removed from input of the integrator 707, therefore the integrator 707 outputs correct DC offset component. Next, the radio receiver performs the reception step (Step 804).

As described above, it becomes possible to output a correct DC offset component from the integrator 707 and to stabilize the output of the integrator 707 in a relatively short time by the time constant τ1 of the integrator 707 used in the DC offset storing step being set relatively smaller than the τ2 used in the reception step.

### MODIFICATION OF SEVENTH EXEMPLARY EMBODIMENT

In this embodiment, the time constant control just as the seventh exemplary embodiment is applied to the radio receiver of the sixth exemplary embodiment. In this embodiment, time constant of the integrator 707 can change according to a time constant control signal provided from the controller 711.

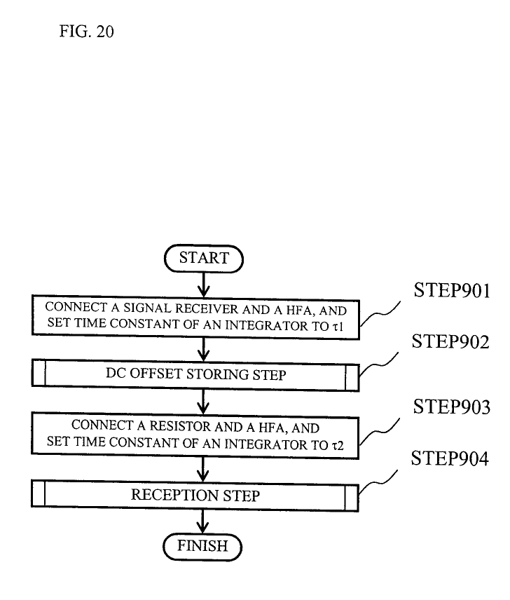

FIG. 20 is a flow chart of an operation of the radio receiver in this embodiment. First, the switch 714 connects the resistor 713 and the HFA 702, and the time constant τ of the integrator 707 is set to τ1, before performing DC offset storing step 902 (Step 901). The τ1 is relatively smaller than τ2 used in reception step 904.

Next, the radio receiver performs the DC offset storing step (Step 902). Content of the DC offset storing step is just as the third exemplary embodiment. Next, the switch 714 connects the signal receiver 701 and the HFA 702, and the time constant τ of the integrator 707 is set to τ2, before performing reception step 904 (Step 903). Next, the radio receiver performs the reception step (Step 904). Content of the reception step is just as the third exemplary embodiment.

As described above, it becomes possible to output a more correct DC offset component from the integrator 707 and to stabilize the output of the integrator 707 in a relatively short time by cutting off the residual DC component of the baseband signal and the time constant τ1 of the integrator 707 used in the DC offset storing step being set relatively smaller than the τ2 used in the reception step.

### EIGHTH EXEMPLARY EMBODIMENT

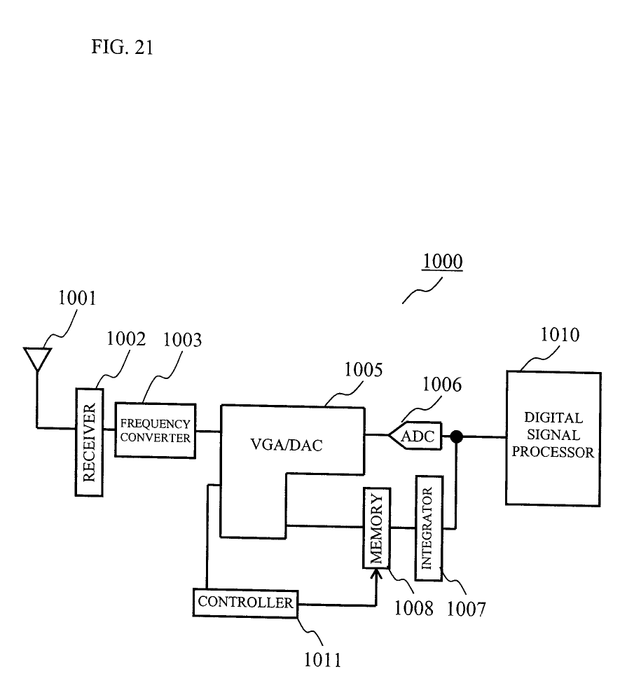

FIG. 21 illustrates a diagram of an example of this embodiment of a radio receiver 1000. The radio receiver 1000 includes an antenna 1001, a receiver 1002, a frequency converter 1003, a subtractor 4, a VGA/DAC 1005, an ADC 1006, an integrator 1007, a memory 1008, a digital signal processor 1010, and a controller 1011.

The radio signal, such as a reception signal, which includes the information transmitted with an antenna 1001, is received. The receiver 1002 performs amplification processing and filtering to the radio signal, which is received by the antenna 1001. The frequency converter 1003 converts the radio signal to a baseband signal.

The VGA/DAC 1005 amplifies a differential signal by subtracting an analog feedback signal, which is an output signal from the memory 1008, from the baseband signal. The VGA/DAC 1005 outputs the amplified differential signal. Gain A of the VGA/DAC 1005 changes according to baseband gain control signal generated by the controller 1011. In this embodiment, resolution of the gain A is 4 bit, for example.

The ADC 1006 converts the output of the VGA/DAC 1005 to a digital signal OUT. That is, the ADC 1006 converts the amplified differential signal to a digital signal. The digital signal processor 1010 reproduces the transmission information from the digital signal OUT.

The integrator 1007 integrates digital value indicated by the digital signal OUT, and outputs the integrated digital value. The memory 1008 stores the integrated digital value to an address designated by write address control signal output from the controller 1011. Moreover, the memory 1008 outputs the integrated digital value from an address designated by read address control signal output from the controller 1011.

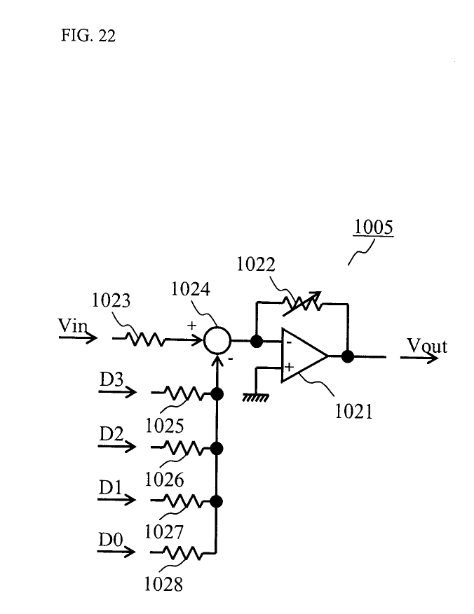

FIG. 22 illustrates a diagram of an example of the VGA/DAC 1005 of the radio receiver 1000. The VGA/DAC 1005 includes a VGA section and a DAC section. The VGA section includes a differential amplifier 1021, a VR (variable resistor) 1022, a resistor 1023. The DAC section includes a subtractor 1024 and resistors 1025-1028.

A non-inverting input terminal of the differential amplifier 1021 is grounded. An output terminal of the differential amplifier 1021 is treated as an output terminal of the VGA/DAC 1005. The VR 1022 connects the output terminal and an inverting input terminal of the differential amplifier 1021. Resistance of the VR 1022 changes according to the baseband gain control signal provided from the control section 1011.

An end of the resistor 1023 is connected to the subtractor 1024, and another end of the resistor 1023 is inputted baseband signal. Each end of resistors 1025-1028 is connected to the subtractor 1024. Each other end of resistors 1025-1028 is applied each of voltages respectively representing bits of the output of the memory 1008.

The resistance of the resistor 1028 corresponding to the lowest bit (Least Significant Bit: LSB) D0 of the output of the memory 1008 is ⅛ of the resistance R_{dac} of the resistor 1025 corresponding to the highest bit (Most Significant Bit: MSB) D3. The resistance of the resistor 1027 corresponding to the second lowest bit D1 of the output of the memory 1008 is ¼ of the resistance R_{dac} of the resistor 1025. The resistance of the resistor 1026 corresponding to the third lowest bit D2 of the output of the memory 1008 is ½ of the resistance R_{dac} of the resistor 1025.

The subtractor 1024 generates a differential signal by subtracting output of the memory 1008, which is provided through one of the resistors 1025-1028, from the baseband signal. The subtractor 1024 provides the differential signal to the inverting input terminal of the differential amplifier 1021.

Then, gain of the VGA/DAC 1005 can be expressed with equation (5).

$$\frac{{V}_{out}}{{V}_{in}} = - \frac{{R}_{2}}{{R}_{1}} \qquad ( 5 )$$

Here, the Vs represents the other end of the resister 1023, the Vₒᵤₜ represents output voltage of the output terminal of the differential amplifier 1021, the R2 represents resistance of the resister 1022, and the R1 represents resistance of the resister 1023. Since the R2 is variable, gain of the VGA/DAC 1005 can be variable.

The resister 1025 converts voltage of the highest bit of the output from the memory 1008 to current. The resister 1026 converts voltage of the second highest bit of the output from the memory 1008 to current. The resister 1027 converts voltage of the second lowest bit of the output from the memory 1008 to current. The resister 1028 converts voltage of the lowest bit of the output from the memory 1008 to current. That is, each of the resisters 1025-1028 converts voltage of corresponding bit to current. Those currents are summed up at the inverting input terminal of the differential amplifier 1021. For example, MSB D3 is converted to the output of the VGA/DAC 1005 as shown by equation (6).

$$\frac{{V}_{out}}{D 3} = - \frac{{R}_{2}}{{R}_{dac} / 8} \qquad ( 6 )$$

A VGA and a DAC may be configured as above.

### NINTH EXEMPLARY EMBODIMENT

Ninth exemplary embodiment of a radio receiver is described below. Configuration described in this embodiment enables cancelling a DC offset component from the output of an ADC well.

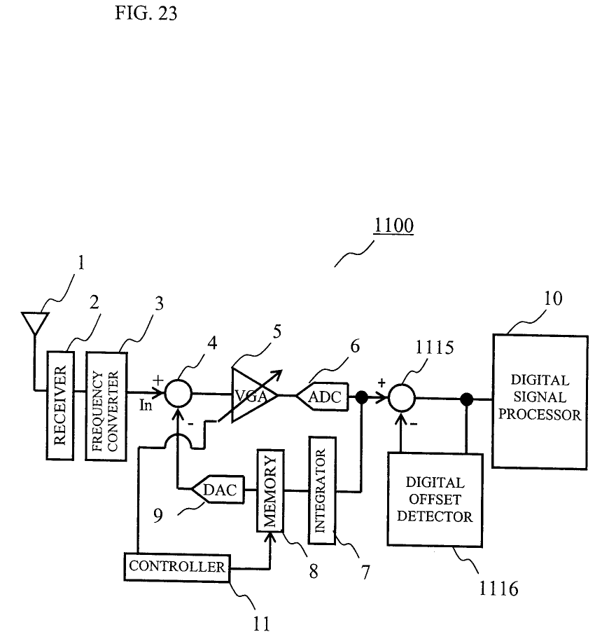

FIG. 23 illustrates a diagram of an example of this embodiment of a radio receiver 1100. In addition to the radio receiver 100 in the first exemplary embodiment, the radio receiver 1100 further includes a subtractor 1115 and a digital offset detector 1116. The subtractor 1115 subtracts the output of the digital offset detector 1116 from digital signal OUT1 which the ADC 6 outputs, and outputs the result as digital signal OUT2.

The digital offset detector 1116 detects and outputs DC offset component of the digital signal OUT2. The digital offset detector 1116 may be an IIR filter, for example.

The subtractor 4, integrator 7, the memory 8, and the DAC 9 make up a negative feedback loop path. An effect of the negative feedback loop path may reduce the DC offset component of the output signal of the VGA 5 within input full scale of the ADC 9. The digital offset detector 1116 removes residual DC offset from the output signal of the VGA 5.

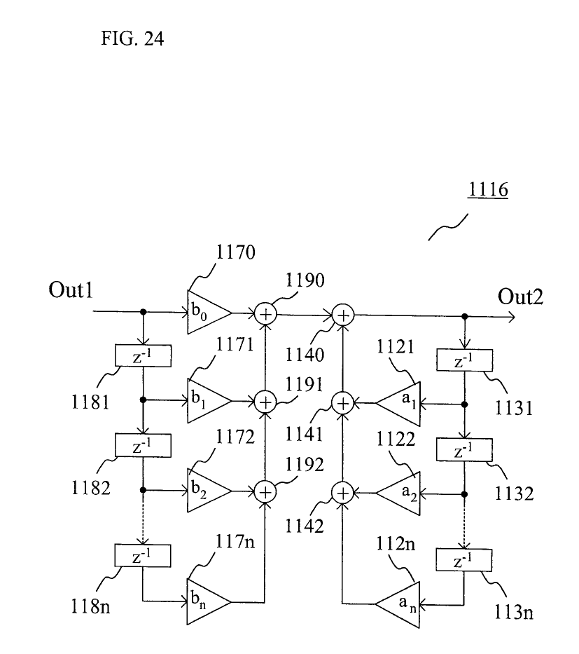

FIG. 24 is a block diagram of a transfer function of the digital offset detector 1116. The digital offset detector 1116 may be an IIR filter expressed with combination of multiplication elements 1121-112n and 1170-117n, delay elements 1131-113n and 1180-118n, and addition elements 1140-114n-1 and 1190-119n-1.

A transfer function of the IIR filter H (z) is expressed by equation (7).

$$H ( z ) = \frac{{\sum }_{k = 0}^{n} {b}_{k} {z}^{- k}}{1 - {\sum }_{k = 1}^{n} {a}_{k} {z}^{- k}} \qquad ( 7 )$$

Coefficients a1-an and b0-bn, which are of multiplication elements 1121-112n and 1170-117n, are set to work as a low-pass filter for extracting DC offset component.

As described above, the DC offset component is cancelled well from output of an ADC well by combination of a negative feedback loop path and a digital offset detector.

Although the invention is shown and described with respect to certain illustrated aspects, it will be appreciated that equivalent alterations and modifications will occur to others skilled in the art upon the reading and understanding of this specification and the annexed drawings. In particular regard to the various functions performed by the above described components, the terms used to describe such components are intended to correspond, unless otherwise indicated, to any component which performs the specified function of the described component (e.g., that is functionally equivalent), even though not structurally equivalent to the disclosed structure, which performs the function in the herein illustrated exemplary aspects of the invention.

What is claimed is:

1. A radio receiver, comprising:
a receiver configured to generate a radio signal from a reception signal;
a frequency converter configured to generate a baseband signal by converting frequency of the radio signal;
a subtractor configured to generate a differential signal by subtracting an analog signal from the baseband signal;
an amplifier configured to generate an amplified difference signal by amplifying the difference signal by a first amplification factor or a second amplification factor;
an analog-digital converter configured to convert the amplified difference signal to a digital signal;
an integrator configured to generate an integration signal by integrating a value indicated by the digital signal;
a memory configured to store the integration signal into a first address when the amplifier amplifies the difference signal by the first amplification factor, and configured to store the integration signal into a second address when the amplifier amplifies the difference signal by the second amplification factor; and
a digital-analog converter configured to generate the analog signal by converting the integration signal stored in the first address of the memory when the amplifier amplifies the difference signal by the first amplification factor, and configured to generate the analog signal by converting the integration signal stored in the second address of the memory when the amplifier amplifies the difference signal by the second amplification factor.

2. The radio receiver according to claim 1, wherein
the receiver includes a pre-amplifier configured to generate the radio signal by amplifying the reception signal by a third amplification factor or a fourth amplification factor;
the memory
stores the integration signal into the first address when the amplifier amplifies the difference signal by the first amplification factor and the pre-amplifier amplifies the reception signal by the third amplification factor,
stores the integration signal into the second address when the amplifier amplifies the difference signal by the second amplification factor and the pre-amplifier amplifies the reception signal by the third amplification factor,
stores the integration signal into a third address when the amplifier amplifies the difference signal by the first amplification factor and the pre-amplifier amplifies the reception signal by the fourth amplification factor, and
stores the integration signal into a fourth address when the amplifier amplifies the difference signal by the second amplification factor and the pre-amplifier amplifies the reception signal by the fourth amplification factor; and
the digital-analog converter
generates the analog signal by converting the integration signal stored in the first address of the memory when the amplifier amplifies the difference signal by the first amplification factor and the pre-amplifier amplifies the reception signal by the third amplification factor,
generates the analog signal by converting the integration signal stored in the second address of the memory when the amplifier amplifies the difference signal by the second amplification factor and the pre-amplifier amplifies the reception signal by the third amplification factor,
generates the analog signal by converting the integration signal stored in the third address of the memory when the amplifier amplifies the difference signal by the first amplification factor and the pre-amplifier amplifies the reception signal by the fourth amplification factor, and
generates the analog signal by converting the integration signal stored in the fourth address of the memory when the amplifier amplifies the difference signal by the second amplification factor and the pre-amplifier amplifies the reception signal by the fourth amplification factor.

3. The radio receiver according to claim 2, further comprising:
a local signal oscillator configured to generate a local signal having a first frequency and a second frequency;
and wherein
the frequency converter generates the baseband signal by converting frequency of the radio signal using the local signal;
the memory
stores the integration signal into the first address when the amplifier amplifies the difference signal by the first amplification factor, the pre-amplifier amplifies the reception signal by the third amplification factor, and the local signal oscillator generates the local signal having the first frequency,
stores the integration signal into the second address when the amplifier amplifies the difference signal by the second amplification factor, the pre-amplifier amplifies the reception signal by the third amplification factor, and the local signal oscillator generates the local signal having the first frequency,
stores the integration signal into the third address when the amplifier amplifies the difference signal by the first amplification factor, the pre-amplifier amplifies the reception signal by the fourth amplification factor, and the local signal oscillator generates the local signal having the first frequency,
stores the integration signal into the fourth address when the amplifier amplifies the difference signal by the second amplification factor, the pre-amplifier amplifies the reception signal by the fourth amplification factor, and the local signal oscillator generates the local signal having the first frequency,
stores the integration signal into a fifth address when the amplifier amplifies the difference signal by the first amplification factor, the pre-amplifier amplifies the reception signal by the third amplification factor, and the local signal oscillator generates the local signal having the second frequency,
stores the integration signal into a sixth address when the amplifier amplifies the difference signal by the second amplification factor, the pre-amplifier amplifies the reception signal by the third amplification factor, and the local signal oscillator generates the local signal having the second frequency,
stores the integration signal into a seventh address when the amplifier amplifies the difference signal by the first amplification factor, the pre-amplifier amplifies the reception signal by the fourth amplification factor, and the local signal oscillator generates the local signal having the second frequency, and
stores the integration signal into an eighth address when the amplifier amplifies the difference signal by the second amplification factor, the pre-amplifier amplifies the reception signal by the fourth amplification factor, and the local signal oscillator generates a local signal having the second frequency; and
the digital-analog converter
generates the analog signal by converting the integration signal stored in the first address of the memory when the amplifier amplifies the difference signal by the first amplification factor, the pre-amplifier amplifies the reception signal by the third amplification factor, and the local signal oscillator generates the local signal having the first frequency,
generates the analog signal by converting the integration signal stored in the second address of the memory when the amplifier amplifies the difference signal by the second amplification factor, the pre-amplifier amplifies the reception signal by the third amplification factor, and the local signal oscillator generates the local signal having the first frequency,
generates the analog signal by converting the integration signal stored in the third address of the memory when the amplifier amplifies the difference signal by the first amplification factor, the pre-amplifier amplifies the reception signal by the fourth amplification factor, and the local signal oscillator generates the local signal having the first frequency,
generates the analog signal by converting the integration signal stored in the fourth address of the memory when the amplifier amplifies the difference signal by the second amplification factor, the pre-amplifier amplifies the reception signal by the fourth amplification factor, and the local signal oscillator generates the local signal having the first frequency,
generates the analog signal by converting the integration signal stored in the fifth address of the memory when the amplifier amplifies the difference signal by the first amplification factor, the pre-amplifier amplifies the reception signal by the third amplification factor, and the local signal oscillator generates the local signal having the second frequency,
generates the analog signal by converting the integration signal stored in the sixth address of the memory when the amplifier amplifies the difference signal by the second amplification factor, the pre-amplifier amplifies the reception signal by the third amplification factor, and the local signal oscillator generates the local signal having the second frequency,
generates the analog signal by converting the integration signal stored in the seventh address of the memory when the amplifier amplifies the difference signal by the first amplification factor, the pre-amplifier amplifies the reception signal by the fourth amplification factor, and the local signal oscillator generates the local signal having the second frequency, and
generates the analog signal by converting the integration signal stored in the eighth address of the memory when the amplifier amplifies the difference signal by the second amplification factor, the pre-amplifier amplifies the reception signal by the fourth amplification factor, and the local signal oscillator generates the local signal having the second frequency.

4. The radio receiver according to claim 1, further comprising:
a digital signal processor configured to reproduce transmission information from the digital signal when the integration signal is not being written into the memory, and configured to stop reproducing transmission information from the digital signal when the integration signal is being written into the memory.

5. The radio receiver according to claim 1, further comprising:
a digital signal processor configured to start reproducing transmission information from the digital signal after finishing the writing of the integration signal into the memory.

6. The radio receiver according to claim 1, further comprising:
a digital signal processor configured to reproduce transmission information from the digital signal when the integration signal is being written into the memory.

7. The radio receiver according to claim 1, wherein
the integrator is capable of setting the integration signal stored in the memory as an initial value of the integration.

8. The radio receiver according to claim 1, wherein
the integrator integrates a value indicated by the digital signal from an initial value, the initial value being the integration signal stored in the first address of the memory when the amplifier amplifies the differential signal by the first amplification factor and being the integration signal stored in the second address of the memory when the amplifier amplifies the differential signal by the second amplification factor.

9. The radio receiver according to claim 2, further comprising:
a digital signal processor configured to reproduce transmission information from the digital signal;
a resistor having a first end which is grounded; and
a switch configured to conduct the reception signal to the pre-amplifier when the digital signal processor is reproducing transmission information from the digital signal, and configured to conduct the reception signal to a second end of the resistor when the digital signal processor is not reproducing transmission information from the digital signal.

10. The radio receiver according to claim 1, further comprising:
a digital signal processor configured to reproduce transmission information from the digital signal; and wherein
a time constant of the integrator is set to a first value when the digital signal processor is not reproducing transmission information from the digital signal, and is set to a second value which is larger than the first value when the digital signal processor is reproducing transmission information from the digital signal.

11. The radio receiver according to claim 1, further comprising:
a digital subtractor configured to generate a trimmed digital signal by subtracting a residual DC offset component of the digital signal from the digital signal; and
a digital offset detector configured to detect the residual DC offset component of the digital signal and to provide a value of the residual DC offset component to the digital subtractor.

12. The radio receiver according to claim 1, wherein
the amplifier generates the amplified differential signal by amplifying the differential signal by a fifth amplification factor which is smaller than the first amplification factor and the second amplification factor, and
the digital-analog converter stops outputting the analog signal when the amplifier amplifies the difference signal by the fifth amplification factor.

13. A method of operating a radio receiver, comprising:
setting a first gain of a variable gain amplifier to a first value and setting a first address of a memory for writing and reading;
storing a first integrated digital value into the first address of the memory;
setting a second gain of the variable gain amplifier to a second value and setting a second address of the memory for writing and reading;
storing a second integrated digital value into the second address of the memory;
inhibiting writing into the memory; and
setting a third gain of the variable gain amplifier to a third value and setting a third address of the memory for reading.

14. A method of operating a radio receiver, comprising:
generating a radio signal from a reception signal;
generating a baseband signal by converting frequency of the radio signal;
generating a differential signal by subtracting an analog signal from the baseband signal;
generating an amplified difference signal by amplifying the difference signal by a first amplification factor or a second amplification factor;
converting the amplified difference signal to a digital signal;
generating an integration signal by integrating a value indicated by the digital signal;
storing the integration signal into a first address when the amplifier amplifies the difference signal by the first amplification factor, and storing the integration signal into a second address when the amplifier amplifies the difference signal by the second amplification factor; and
generating the analog signal by converting the integration signal stored in the first address when the amplifier amplifies the difference signal by the first amplification factor, and generating the analog signal by converting the integration signal stored in the second address when the amplifier amplifies the difference signal by the second amplification factor.

15. The method according to claim 14, further comprising:
reproducing transmission information from the digital signal when the integration signal is not being written into a memory, and stopping reproducing transmission information from the digital signal when the integration signal is being written into the memory.

16. The method according to claim 14, further comprising:
starting reproducing transmission information from the digital signal after finishing storing of the integration signal into a memory.

17. The method according to claim 14, further comprising:
reproducing transmission information from the digital signal when storing the integration signal into a memory.

18. The method according to claim 14, wherein a value indicated by the digital signal from an initial value, the initial value being the integration signal stored in the first address when the amplifier amplifies the differential signal by the first amplification factor and being the integration signal stored in the second address when the amplifier amplifies the differential signal by the second amplification factor.

19. The method according to claim 14, further comprising:
reproducing transmission information from the digital signal, wherein a time constant of the integrator is set to a first value when the digital signal processor is not reproducing transmission information from the digital signal, and is set to a second value which is larger than the first value when the digital signal processor is reproducing transmission information from the digital signal.

20. The method according to claim 14, further comprising:
generating a trimmed digital signal by subtracting a residual DC offset component of the digital signal from the digital signal; and
detecting the residual DC offset component of the digital signal and providing a value of the residual DC offset component to a digital subtractor.
